(19) United States
(12) Patent Application Publication
(10) Pub. No.: US 2024/0322339 A1
(43) Pub. Date: Sep. 26, 2024

(54) BATTERY PACK

(71) Applicant: HONDA MOTOR CO., LTD., Tokyo (JP)

(72) Inventors: Ryo ISHIZAKI, Saitama (JP); Ken YASUI, Saitama (JP); Masaaki TATSUWAKI, Saitama (JP)

(73) Assignee: HONDA MOTOR CO., LTD., Tokyo (JP)

(21) Appl. No.: 18/588,032

(22) Filed: Feb. 27, 2024

(30) Foreign Application Priority Data
Mar. 24, 2023 (JP) 2023-048585

(51) Int. Cl. H01M 50/262; H01M 10/42; H01M 50/249

(52) U.S. Cl. CPC H01M 50/262; H01M 10/425; H01M 50/249; H01M 2220/20

(57) ABSTRACT

A battery pack is mounted on a vehicle. The battery pack has a battery module, a battery case to which the battery module is fixed at a module fixing portion, a frame member extending in a front-rear direction of the vehicle and constructed above the battery module, and a junction box disposed on the frame member. The frame member is fixed to the battery case or the battery module at a first fixing portion positioned in front of the junction box and a second fixing portion positioned behind the junction box. The junction box is not fixed to the battery module and the battery case but is fixed to the frame member at an intermediate fixing portion. The module fixing portion and the first and second fixing portions are fixed by rigid coupling without any elastic member. The intermediate fixing portion is fixed by elastic coupling through an elastic member.

### CROSS-REFERENCE TO RELATED APPLICATIONS

This application is based on and claims priority under 35 USC 119 from Japanese Patent Application No. 2023-048585 filed on Mar. 24, 2023, the entire content of which is incorporated herein by reference.

### TECHNICAL FIELD

The present disclosure relates to a battery pack capable of being mounted on a moving body such as a vehicle.

### BACKGROUND ART

In recent years, efforts to realize a low-carbon society or a decarbonized society become active, and research and development on electrification techniques are conducted to reduce CO2 emission and improve energy efficiency in vehicles.

Batteries play an important role in the electrification technique. An electric vehicle is equipped with a battery pack accommodating a battery. In addition to a battery module, the battery pack also accommodates a junction box in which electronic components such as conductive members, fuses, and contacts are arranged.

For example, in the battery pack described in JP2022-077357A, it is described that a junction box is mounted on an upper deck constructed above the battery module.

In recent years, there has been a trend for vehicles to be equipped with a larger battery in order to extend cruising distances thereof, and there is a risk that vibration of the battery may become large at a specific frequency. Especially, depending on how the junction box is mounted, the vibration of the battery at a specific frequency may become large.

### SUMMARY OF INVENTION

The present disclosure provides a battery pack capable of reducing vibration at a specific frequency.

An aspect of the present disclosure relates to a battery pack to be mounted on a vehicle, the battery pack including:
a battery module in which a plurality of cells are laminated;
a battery case to which the battery module is fixed at a module fixing portion;
a frame member extending in a front-rear direction of the vehicle and constructed above the battery module; and
a junction box disposed on the frame member,
in which the frame member is fixed to the battery case or the battery module at a first fixing portion positioned in front of the junction box and a second fixing portion positioned behind the junction box,
the junction box is not fixed to the battery module and the battery case, but is fixed to the frame member at an intermediate fixing portion positioned between the first fixing portion and the second fixing portion,
the module fixing portion, the first fixing portion, and the second fixing portion are fixed by rigid coupling without using any elastic member, and
the intermediate fixing portion is fixed by elastic coupling through an elastic member.

According to the present disclosure, vibration of a battery pack can be reduced at a specific frequency.

### BRIEF DESCRIPTION OF DRAWINGS

Exemplary embodiment(s) of the present invention will be described in detail based on the following figures, wherein:

FIG. 1 is an exploded perspective view of a battery pack 1;

FIG. 2 is an exploded perspective view of a battery module 10;

FIG. 3 is a diagram illustrating an example of fixing of a junction box 11 and fixing of an upper frame 34;

FIG. 4 is an enlarged view of a fixing portion of the junction box 11;

FIG. 5 is a diagram illustrating another example of fixing of the junction box 11 and fixing of the upper frame 34; and

FIGS. 6A to 6C are explanatory diagrams of vibration modes.

### DESCRIPTION OF EMBODIMENTS

Hereinafter, a battery pack of an embodiment of the present disclosure is described based on the accompanying drawings.

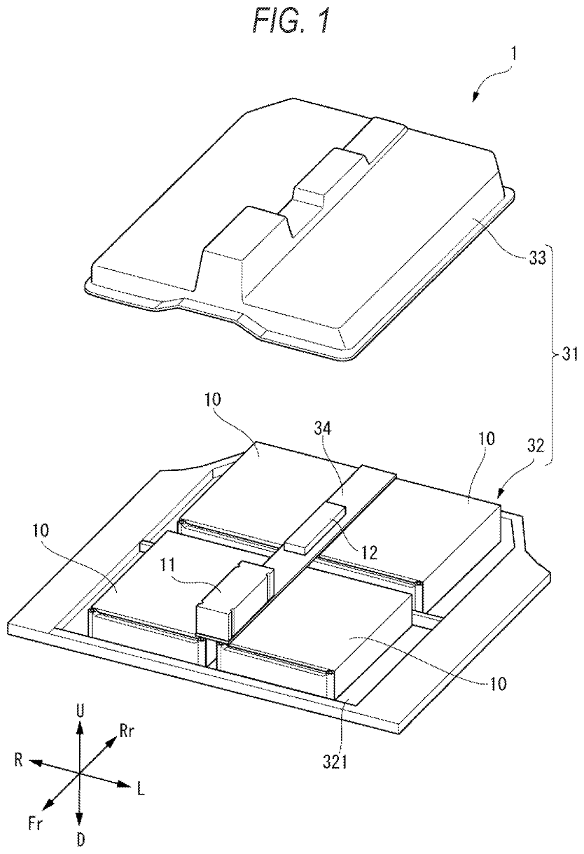

A battery pack 1 according to an embodiment of the present disclosure is configured to be able to be mounted on an electric vehicle such as a hybrid vehicle, an electric automobile, or a fuel cell vehicle. As shown in FIG. 1, the battery pack 1 includes four battery modules 10, a junction box 11, an auxiliary device 12, and a battery case 31 that accommodates the above. The four battery modules 10 are arranged in two rows in a front-rear direction and in two rows in a left-right direction. Note that the number of the battery modules 10 can be freely set as long as there are two or more, and arrangement thereof is not particularly limited.

The battery modules 10 are electrically connected to each other via electrical connection members (not shown). Electric power stored in the battery modules 10 is supplied to a motor or the like serving as a drive source of the vehicle. Note that in the following description, the four battery modules 10 may be collectively referred to as a battery. The auxiliary device 12, the junction box 11, and the battery module 10 have weight light to great in this order. That is, a weight of the auxiliary device 12 is smaller than that of the junction box 11, and the weight of the junction box 11 is smaller than that of the battery module 10.

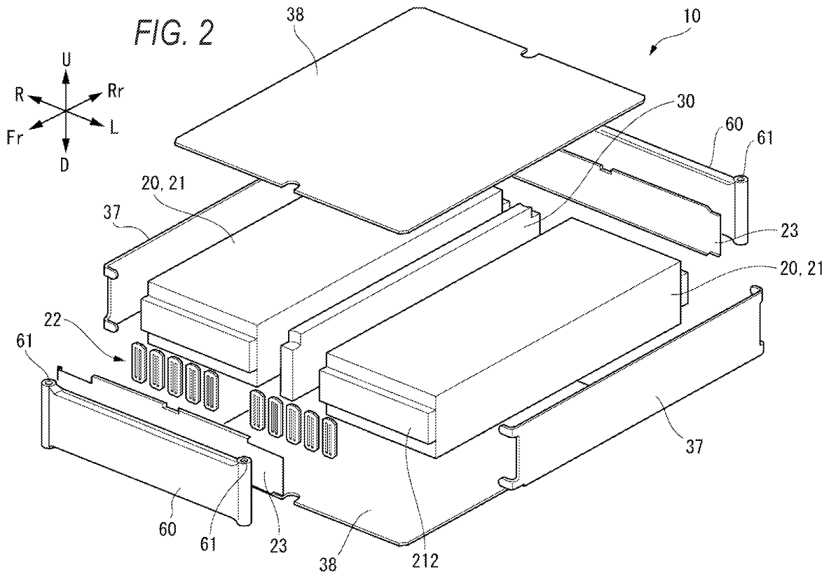

As shown in FIG. 2, the battery module 10 includes a cell laminate 20 in which a plurality of cells 21 are laminated, an intermediate plate 30, a pair of end plates 37, a pair of restraining members 38, and a pair of cover plates 60.

The cell laminate 20 is configured by the plurality of cells 21 laminating in a left-right direction. The intermediate plate 30 is provided at an intermediate portion in a lamination direction (here, the left-right direction) of the plurality of cells 21. Two or more intermediate plates 30 may be provided. The pair of end plates 37 are provided on two ends of the plurality of cells 21 in the lamination direction, respectively. The pair of restraining members 38 face each other in an upper-lower direction and are coupled to the pair of end plates 37 to restrain the plurality of cells 21. The pair of cover plates 60 are provided outward than the plurality of cells 21 in the front-rear direction and extend in the lamination direction. The two cover plates 60 are provided facing each other in the front-rear direction, and are fixed to a front end or a rear end of the pair of end plates 37 to form a front surface or a rear surface of the battery module 10. As viewed in the front-rear direction, the cover plates 60 cover bus bars 22 that connect electrode tabs 212 of the cells 21 and the electrode tabs 212 of the cells 21 through bus bar covers 23 having an electrical insulation property, so as to protect the bus bars 22 and the electrode tabs 212. No electrical terminal is attached to the cover plates 60.

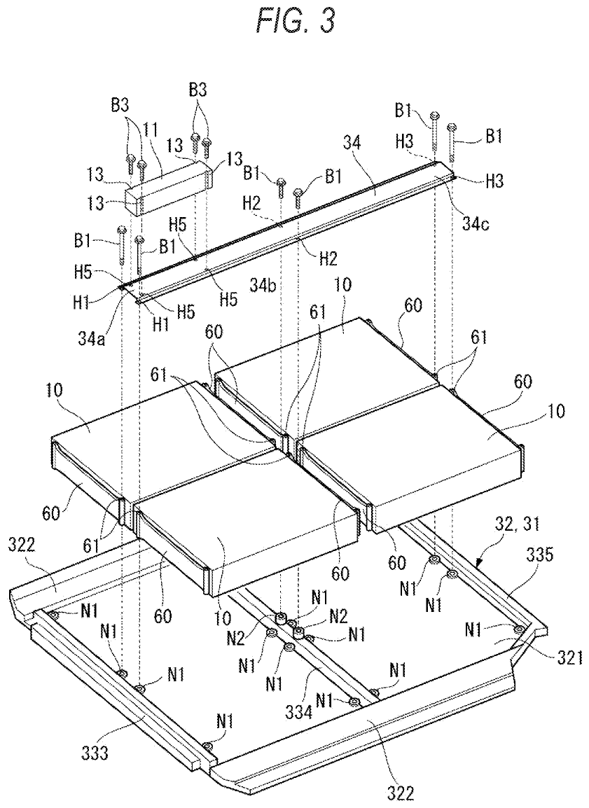

Referring also to FIG. 3, through holes 61 penetrating in the upper-lower direction are provided on left and right sides of the cover plate 60, respectively. The battery module 10 is fixed to the battery case 31 by fastening bolts B1 passing through the through holes 61 to module fixing portions N1 formed in cross members 333 to 335, which will be described later. When rigid fixing using bolts and nuts without using elastic members is referred to as rigid coupling, the battery module 10 is rigidly coupled to the battery case 31.

Returning to FIG. 1, the battery case 31 includes a battery tray 32 on which the plurality of battery modules 10 are placed, and an upper cover 33 that covers the battery modules 10 from above.

As shown in FIG. 3, the battery tray 32 includes a bottom plate 321 on which the battery modules 10 are placed, a pair of side frames 322 provided on left and right sides of the bottom plate 321, respectively, a front cross member 333, a central cross member 334, and a rear cross member 335 that couple the pair of side frames 322.

The front cross member 333 constitutes a front wall of the battery case 31, and the rear cross member 335 constitutes a rear wall of the battery case 31. The central cross member 334 divides an interior of the battery case 31 into two spaces, which are a front space and a rear space. Two battery modules 10 are arranged on the left and right side in the front space, and two battery modules 10 are arranged on the left and right side in the rear space. The cross members 333 to 335 are provided with module fixing portions N1 that fix the battery modules to coupling portions with the battery tray 32, and further, the central cross member 334 is provided with frame fixing portions N2 for fixing an upper frame 34 to a central upper portion.

As shown in FIG. 1, the upper frame 34 extending in the front-rear direction is bridged over the two battery modules 10 positioned on the left side and the two battery modules 10 positioned on the right side at left and right central portions of the battery case 31. On the upper frame 34, the junction box 11 is disposed on the front side, and the auxiliary device 12 is disposed on the rear side. Electronic components such as conductive members, fuses, and contactors that connect an electric power system inside the battery case 31 and a DC line outside the battery case 31 are arranged in the junction box 11. The auxiliary device 12 is, for example, a battery ECU.

As shown in FIG. 3, a front end 34a of the upper frame 34 is fixed to the battery modules 10 and the battery case 31 by the bolts B1 provided on the left and right sides thereof. More specifically, the front end 34a of the upper frame 34 is provided with bolt holes H1 on the left and right sides thereof. The bolt hole H1 on the right side is fastened together with the right front battery module 10 to the module fixing portion N1 provided at a lower portion of the front cross member 333 of the battery case 31 by the bolt B1 passing through the left through hole 61 of the cover plate 60 positioned in front of the right front battery module 10. The bolt hole H1 on the left side is fastened together with the left front battery module 10 to the module fixing portion N1 provided at the lower portion of the front cross member 333 of the battery case 31 by the bolt B1 passing through the right through hole 61 of the cover plate 60 positioned in front of the left front battery module 10.

By fastening the front end 34a of the upper frame 34 to the battery case 31 together with the battery module 10 with the bolts B1, the upper frame 34 is rigidly fastened to the battery module 10 and to the battery case 31. Note that the position and number of the bolt holes H1 can be changed as appropriate as long as they are positioned in front of the junction box 11.

A central portion 34b of the upper frame 34 is provided with bolt holes H2 on left and right sides, and is fixed to the frame fixing portions N2 provided at a central upper portion of the central cross member 334 by the bolts B1 passing through the bolt holes H2. That is, the central portion 34b of the upper frame 34 is rigidly fastened to the central cross member 334 of the battery case 31. Note that the bolt holes H2 are positioned behind the junction box 11.

A rear end 34c of the upper frame 34 is fixed to the battery modules 10 and the battery case 31 by the bolts B1 provided on the left and right sides thereof. More specifically, the rear end 34c of the upper frame 34 is provided with bolt holes H3 on the left and right sides thereof. The bolt hole H3 on the right side is fastened together with the right rear battery module 10 to the module fixing portion N1 provided at a lower portion of the rear cross member 335 of the battery case 31 by the bolt B1 passing through the left through hole 61 of the cover plate 60 positioned behind the right rear battery module 10. The bolt hole H3 on the left side is fastened together with the left rear battery module 10 to the module fixing portion N1 provided at the lower portion of the rear cross member 335 of the battery case 31 by the bolt B1 passing through the right through hole 61 of the cover plate 60 positioned behind the left rear battery module 10.

By fastening the rear end 34c of the upper frame 34 to the battery case 31 together with the battery module 10 with the bolts B1, the upper frame 34 is rigidly fastened to the battery module 10 and to the battery case 31. Note that the bolt holes H3 are positioned behind the junction box 11.

That is, the upper frame 34 is rigidly coupled to the battery case 31 similarly to the battery module 10. Note that in the present embodiment, the front end 34a and the rear end 34c of the upper frame 34 are fastened to the battery case 31 together with the battery modules 10, but the upper frame 34 may be rigidly fastened only to the battery case 31 to which the battery modules 10 are rigidly fastened, or may be rigidly fastened only to the battery modules 10, and the battery modules 10 may be rigidly fastened to the battery case 31.

Since the battery modules 10 and the upper frame 34 are rigidly fastened to the battery case 31 in this way, the battery modules 10, the upper frame 34, and the battery case 31 vibrate together in accordance with movement in the upper-lower direction of the vehicle.

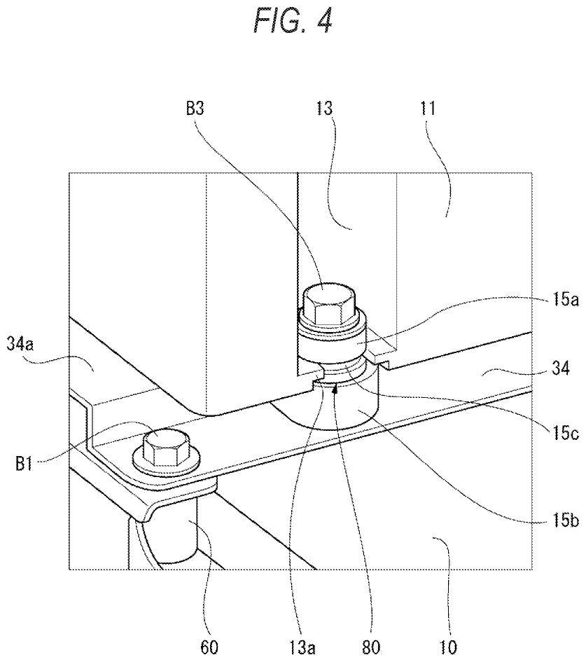

On the other hand, the junction box 11 is not fixed to the battery modules 10 and the battery case 31, but is fixed to the upper frame 34 via a mount rubber 80, as shown in FIG. 4. More specifically, as shown in FIG. 3, the upper frame 34 is provided with four bolt holes H5 between the left and right bolt holes H1 positioned in the front end 34a of the upper frame 34 and the left and right bolt holes H2 positioned in the central portion 34b in the front-rear direction. The junction box 11 is provided with notches 13 at four positions in total, two at a front end and two at a rear end thereof, at positions corresponding to the bolt holes H5 of the upper frame 34.

The mount rubber 80 is disposed in the notch 13. The mount rubber 80 is made of an elastic material and has an overall cylindrical shape. More specifically, the mount rubber 80 includes a small diameter portion 15c provided between an upper large diameter portion 15a and a lower large diameter portion 15b, and engages with a plate-shaped locking piece 13a formed in the notch 13. The junction box 11 is fixed to the upper frame 34 by screwing bolts B3 passing through the mount rubbers 80 into the bolt holes H5 or nuts in the upper frame 34.

That is, while the battery modules 10 and the upper frame 34 are rigidly fastened to the battery case 31, the junction box 11 is fixed to the upper frame 34 by elastic coupling through the mount rubbers 80.

Therefore, the junction box 11 tends to vibrate differently from the battery. That is, by adjusting the disposition of the junction box 11, a weight of the junction box 11, elasticity of the mount rubbers 80, rigidity of the upper frame 34, and the like, a phase of the battery and a phase of the junction box 11 are shifted and vibration of the battery pack 1 can be reduced.

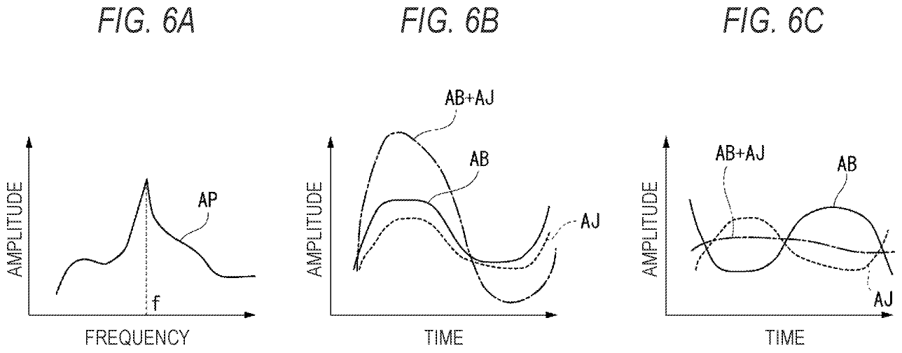

To describe with reference to FIGS. 6A and 6B, when the junction box 11 is rigidly fastened to the battery modules 10 and the upper frame 34, at a specific frequency f, a phase AB of the battery and a phase AJ of the junction box 11 become the same phase, and an amplitude AP of the battery modules 10 is amplified. It is difficult to shift the phase AB of the battery and the phase AJ of the junction box 11. In contrast, by fixing the junction box 11 to the upper frame 34 by elastic coupling through the mount rubbers 80 and adjusting the disposition of the junction box 11 as described above, the phase AJ of the junction box 11 can be easily shifted with respect to the phase AB of the battery.

The method for shifting the phase AJ of the junction box 11 with respect to the phase AB of the battery is such that in frequency bands thereof during traveling of the vehicle assumed when mounted on the vehicle, frequencies with maximum amplitude thereof are set to be different to prevent vibration exceeding a predetermined value. Most preferably, as shown in FIG. 6C, the phase AB of the battery and the phase AJ of the junction box 11 are set to be opposite phases.

In this way, according to the present disclosure, it is possible to reduce the amplitude of the battery pack 1 at a specific frequency assumed when the vehicle is traveling. Therefore, it is possible to reduce occurrence of vibration exceeding a predetermined value in the frequency bands during traveling of the vehicle assumed when mounted on the vehicle. Since no special member is required for vibration reduction, an increase in weight can be avoided. Furthermore, by stabilizing a vibration mode, it becomes possible to mount an even larger battery, and a cruising distance can be extended.

Furthermore, if the phases are set to be opposite at a specific frequency f, when the junction box 11 vibrates, the battery modules 10 are pulled in a direction opposite to the junction box 11. Here, the upper frame 34 to which the junction box 11 is fixed is fixed to the cover plates 60 of the battery modules 10 to which no electrical terminal is attached. Therefore, there is no need to provide an additional protection structure to protect the electrical terminals from stress due to the opposite phases.

The auxiliary device 12 is disposed on the upper frame 34 behind the junction box 11. Although not shown, the auxiliary device 12 is rigidly fastened between the left and right bolt holes H2 positioned in the central portion 34b of the upper frame 34 and the left and right bolt holes H3 positioned in the rear end 34c of the upper frame 34.

In the embodiment described above, positions fixed using the mount rubbers 80 are concentrated around the junction box 11 between the bolt holes H1 and bolt holes H2. By concentrating the fixing portions of the mount rubbers 80 in this way, the vibration mode can be adjusted more easily than when the fixing portions of the mount rubbers 80 are dispersed in the battery modules 10 and the like.

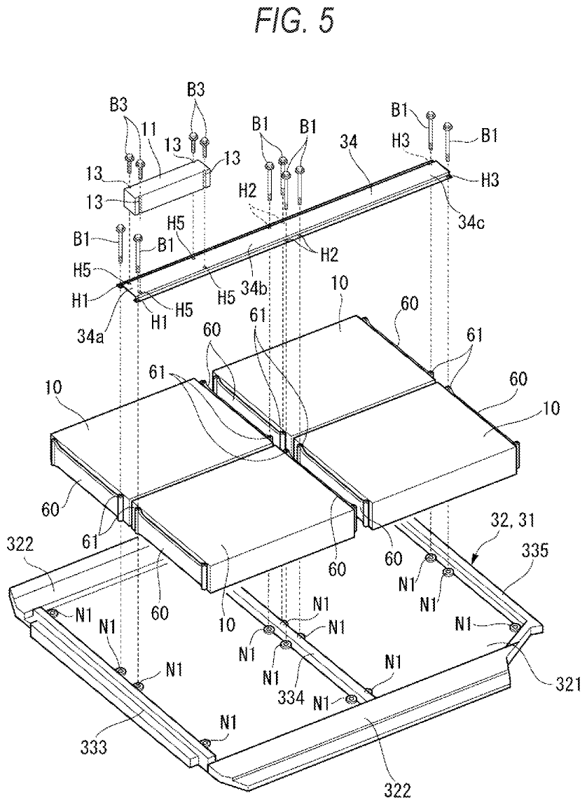

Next, a modification of the above embodiment will be described with reference to FIG. 5.

In the modification described below, only differences from the above embodiment will be described. In the above embodiment, the central portion 34b of the upper frame 34 is fixed only to the central cross member 334 by the bolts B1 passing through the two bolt holes H2 positioned on the left and right side, but in the present modification, the central portion 34b is fixed to the battery modules 10 and the central cross member 334.

That is, in the central portion 34b of the upper frame 34 of the present modification, four bolt holes H2 are provided on the front, rear, left and right sides. The bolt hole H2 on the right front side is fastened together with the right front battery module 10 to the module fixing portion N1 provided at the lower portion of the central cross member 334 of the battery case 31 by the bolt B1 passing through the left through hole 61 of the cover plate 60 positioned behind the right front battery module 10. The bolt hole H2 on the left front side is fastened together with the left front battery module 10 to the module fixing portion N1 provided at the lower portion of the central cross member 334 of the battery case 31 by the bolt B1 passing through the right through hole 61 of the cover plate 60 positioned behind the left front battery module 10.

The bolt hole H2 on the right rear side is fastened together with the right rear battery module 10 to the module fixing portion N1 provided at the lower portion of the central cross member 334 of the battery case 31 by the bolt B1 passing through the left through hole 61 of the cover plate 60 positioned in front of the right rear battery module 10. The bolt hole H2 on the left rear side is fastened together with the left rear battery module 10 to the module fixing portion N1 provided at the lower portion of the central cross member 334 of the battery case 31 by the bolt B1 passing through the right through hole 61 of the cover plate 60 positioned in front of the left rear battery module 10.

In the present modification, in addition to the front end 34a and the rear end 34c of the upper frame 34, the central portion 34b is also fastened together with the battery module to the battery case 31. Then, in each battery module 10, both the cover plates 60 positioned in the front-rear direction are fixed to the upper frame 34. Therefore, when the upper frame 34 vibrates, the upper frame 34 pulls both ends of all the battery modules 10, so that a tensile load is prevented from acting only on one side of the battery module 10 in the front-rear direction.

Although various embodiments have been described above with reference to the drawings, it is needless to say that the present invention is not limited to these examples. It is apparent that those skilled in the art may conceive of various modifications and changes within the scope described in the claims, and it is understood that such modifications and changes naturally fall within the technical scope of the present invention. In addition, respective constituent elements in the above-described embodiments may be freely combined without departing from the gist of the invention.

In the above embodiment, the junction box 11 is disposed between the left and right bolt holes H1 positioned in the front end 34a of the upper frame 34 and the left and right bolt holes H2 positioned in the central portion 34b of the upper frame 34, and the auxiliary device 12 is disposed between the left and right bolt holes H2 positioned in the central portion 34b of the upper frame 34 and the left and right bolt holes H3 positioned in the rear end 34c of the upper frame 34, which are fixing portions of the upper frame 34.

For example, the junction box 11 may be disposed between the left and right bolt holes H2 positioned in the central portion 34b of the upper frame 34 and the left and right bolt holes H3 positioned in the rear end 34c of the upper frame 34. The auxiliary device 12 may be disposed between the left and right bolt holes H1 positioned in the front end 34a of the upper frame 34 and the left and right bolt holes H2 positioned in the central portion 34b of the upper frame 34, which are fixing portions of the upper frame 34.

As long as the mount rubbers 80 are elastically coupled, it is not limited to the case where all the mount rubbers are formed of an elastic member, and a part thereof may be formed of other members such as metal and resin.

In the present description, at least the following matters are described.

Corresponding constituent elements and the like in the embodiments described above are shown in parentheses, but the present invention is not limited thereto.

(1) A battery pack (battery pack 1) to be mounted on a vehicle, the battery pack including:
a battery module (battery module 10) in which a plurality of cells are laminated;
a battery case (battery case 31) to which the battery module is fixed at a module fixing portion (module fixing portion N1);
a frame member (upper frame 34) extending in a front-rear direction of the vehicle and constructed above the battery module; and
a junction box (junction box 11) disposed on the frame member,
in which the frame member is fixed to the battery case or the battery module at a first fixing portion (bolt hole H1) positioned in front of the junction box and a second fixing portion (bolt hole H2, bolt hole H3) positioned behind the junction box,
the junction box is not fixed to the battery module and the battery case, but is fixed to the frame member at an intermediate fixing portion (bolt hole H5) positioned between the first fixing portion and the second fixing portion,
the module fixing portion, the first fixing portion, and the second fixing portion are fixed by rigid coupling without using any elastic member, and
the intermediate fixing portion is fixed by elastic coupling through an elastic member (mount rubber 80).

According to (1), since the junction box is not fixed to the battery module and battery case, the junction box is likely to vibrate differently from the battery. In other words, by adjusting the disposition and weight of the junction box, the elasticity of the intermediate fixing portion, the rigidity of the frame member, and the like, for a natural number of vibration (frequency) where the amplitude of the battery pack increases, vibration of the battery pack can be reduced by shifting the phase of the battery with respect to the phase of the junction box. By combining the rigid coupling fixing and the elastic coupling fixing to concentrate the elastic coupling positions on the intermediate fixing portion, the vibration mode can be adjusted more easily than when no elastic coupling is used or when the fixing portions of the elastic coupling are dispersed in the battery module and the like. An increase in weight for vibration reduction can be avoided. Furthermore, by stabilizing a vibration mode, it becomes possible to mount an even larger battery, and a cruising distance can be extended.

(2) The battery pack according to (1),
in which the battery module includes:
   a cell laminate (cell laminate 20);
   end plates (end plate 37) extending in the front-rear direction and provided at both ends of the cell laminate in a lamination direction, respectively; and
   a cover plate (cover plate 60) extending in a vehicle width direction and covering a cell terminal and having no electrical terminal attached, and
the frame member is fixed to the cover plate at the first fixing portion and the second fixing portion.

According to (2), the frame member fixing the junction box can directly pull the battery module. The vibration of the junction box and the vibration of the battery module can be adjusted to be in opposite phases at the natural number of vibration leading to undesirable amplitudes, but in this case, since the frame member pulls the cover plate to which no electrical terminal is attached, there is no need to provide an additional protection structure to protect the terminals from stress due to the opposite phases.

(3) The battery pack according to (2),
in which the frame member is further fixed to the battery module by the rigid coupling at a third fixing portion (bolt hole H3) positioned on a side opposite to the first fixing portion with respect to the second fixing portion, and
the frame member is fixed to both ends of all the battery modules in the battery case at the first fixing portion, the second fixing portion, and the third fixing portion.

According to (3), since the frame member that fixes the junction box directly pulls both ends of all the battery modules, the tensile load is prevented from acting on only one side of the battery module in the front-rear direction, and the tensile load acts on both ends of all the battery modules within the battery case.

(4) The battery pack according to (1),
in which the elastic member of the intermediate fixing portion is formed of rubber.

According to (4), by changing the material of rubber without changing the structural design, it is possible to change an elastic force of the intermediate fixing portion, and the frequency at which the junction box swings. In this way, as compared with using a metal elastic body such as a coil spring, a leaf spring, or a disc spring as the elastic member, adjustment of the vibration mode at the natural number of vibration that leads to undesirable amplitudes is facilitated.

(5) The battery pack according to (1),
in which the frame member is provided with an auxiliary device in front of the first fixing portion or behind the second fixing portion, and
the auxiliary device, the junction box, and the battery module have weight light to great in this order.

According to (5), the vibration of the battery pack can be easily reduced by swinging the junction box, which has a certain weight to cause an opposite phase.

What is claimed is:

1. A battery pack to be mounted on a vehicle, the battery pack comprising:
a battery module in which a plurality of cells are laminated;
a battery case to which the battery module is fixed at a module fixing portion;
a frame member extending in a front-rear direction of the vehicle and constructed above the battery module; and
a junction box disposed on the frame member,
wherein the frame member is fixed to the battery case or the battery module at a first fixing portion positioned in front of the junction box and a second fixing portion positioned behind the junction box,
the junction box is not fixed to the battery module and the battery case, but is fixed to the frame member at an intermediate fixing portion positioned between the first fixing portion and the second fixing portion,
the module fixing portion, the first fixing portion, and the second fixing portion are fixed by rigid coupling without using any elastic member, and
the intermediate fixing portion is fixed by elastic coupling through an elastic member.

2. The battery pack according to claim 1,
wherein the battery module includes:
a cell laminate;
end plates extending in the front-rear direction and provided at both ends of the cell laminate in a lamination direction, respectively; and
a cover plate extending in a vehicle width direction and covering a cell terminal and having no electrical terminal attached, and
the frame member is fixed to the cover plate at the first fixing portion and the second fixing portion.

3. The battery pack according to claim 2,
wherein the frame member is further fixed to the battery module by the rigid coupling at a third fixing portion positioned on a side opposite to the first fixing portion with respect to the second fixing portion, and
the frame member is fixed to both ends of all the battery modules in the battery case at the first fixing portion, the second fixing portion, and the third fixing portion.

4. The battery pack according to claim 1,
wherein the elastic member of the intermediate fixing portion is formed of rubber.

5. The battery pack according to claim 1,
wherein the frame member is provided with an auxiliary device in front of the first fixing portion or behind the second fixing portion, and
the auxiliary device, the junction box, and the battery module have weight light to great in this order.
